(19) United States
(12) Patent Application Publication
(10) Pub. No.: US 2011/0172903 A1
(43) Pub. Date: Jul. 14, 2011

(54) Points of avoidance in a personal navigation device

(76) Inventor: Daniel Colin Farr, Auckland (NZ)

(21) Appl. No.: 12/684,964

(22) Filed: Jan. 10, 2010

(51) Int. Cl. G01C 21/36

(52) U.S. Cl. 701/201

(57) ABSTRACT

A method of incorporating points of avoidance into navigation instructions generated by a personal navigation device includes storing a plurality of points of avoidance into a memory of the personal navigation device, each point of avoidance having corresponding position coordinates, receiving a request from a user of the personal navigation device to provide navigation instructions to a destination, creating a route that avoids the points of avoidance, and providing navigation instructions to guide the user on the created route.

### BACKGROUND OF THE INVENTION

1. Field of the Invention

The invention relates to a personal navigation device, and more particularly, to a personal navigation device that avoids specific points of avoidance selected by users when generating routing instructions for the users.

2. Description of the Prior Art

Global Positioning System (GPS) based navigation devices are well known and are widely employed as in-car navigation devices. Common functions of a navigation device include providing a map database for generating navigation instructions that are then shown on a display of the navigation device. These navigation devices are often mounted on or in the dashboard of a vehicle using a suction mount or other mounting means.

The term “navigation device” refers to a device that enables a user to navigate to a pre-defined destination. The device may have an internal system for receiving location data, such as a GPS receiver, or may merely be connectable to a receiver that can receive location data. The device may compute a route itself, or communicate with a remote server that computes the route and provides navigation information to the device, or a hybrid device in which the device itself and a remote server both play a role in the route computation process. Portable GPS navigation devices are not permanently integrated into a vehicle but instead are devices that can readily be mounted in or otherwise used inside a vehicle. Generally (but not necessarily), they are fully self-contained—i.e. include an internal GPS antenna, navigation software and maps and can hence plot and display a route to be taken.

Personal navigation devices strive to guide users on the best possible route in order to minimize the time needed to travel from one point to another. However, users that are familiar with a given area often have their own personal preferences of areas, roads, or road junctions that they wish to avoid. For example, the personal navigation device may instruct a user to turn left at the end of a road, whereas the user knows that turning right is clearly the better choice. This disparity between the generated instructions and the user's own knowledge of the area causes frustration for the user, and may lead to the user not using the personal navigation device much at all if this problem occurs frequently enough.

In addition to avoiding particular locations in every instance, the user may also wish to avoid areas, roads, or road junctions only at certain times of day, such as during rush hour. Unfortunately, the conventional personal navigation device does not offer this functionality to the user in a simple and convenient way.

### SUMMARY OF THE INVENTION

It is therefore one of the primary objectives of the claimed invention to provide a method of creating routing instructions with the personal navigation device while avoiding points of avoidance.

According to an exemplary embodiment of the claimed invention, a method of incorporating points of avoidance into navigation instructions generated by a personal navigation device is disclosed. The method includes storing a plurality of points of avoidance into a memory of the personal navigation device, each point of avoidance having corresponding position coordinates, receiving a request from a user of the personal navigation device to provide navigation instructions to a destination, creating a route that avoids the points of avoidance, and providing navigation instructions to guide the user on the created route.

According to another exemplary embodiment of the claimed invention, a personal navigation device for avoiding points of avoidance in navigation instructions generated by the personal navigation device is disclosed. The personal navigation device includes a memory for storing a plurality of points of avoidance, each point of avoidance having corresponding position coordinates, a user interface for receiving a request from a user of the personal navigation device to provide navigation instructions to a destination, routing software for creating a route that avoids the points of avoidance and providing navigation instructions to guide the user on the created route, and a processor for controlling operation of the personal navigation device and controlling execution of the routing software.

It is an advantage that users can create or download points of avoidance that the user wishes to avoid when receiving navigation instructions from the personal navigation device. In this way, the user can have a more enjoyable trip that is free of the trouble spots that the user wishes to avoid. In addition, the points of avoidance can help the personal navigation device create a faster and safer route for the user.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a personal navigation device according to the present invention.

FIG. 2 is a flowchart illustrating a method of avoiding points of avoidance while generating navigation instructions with the personal navigation device according to the present invention.

FIG. 3 shows categories of points of avoidance that may be selected by the user of the personal navigation device.

FIG. 4 shows an example of a new point of avoidance being created and all of the associated parameters.

### DETAILED DESCRIPTION

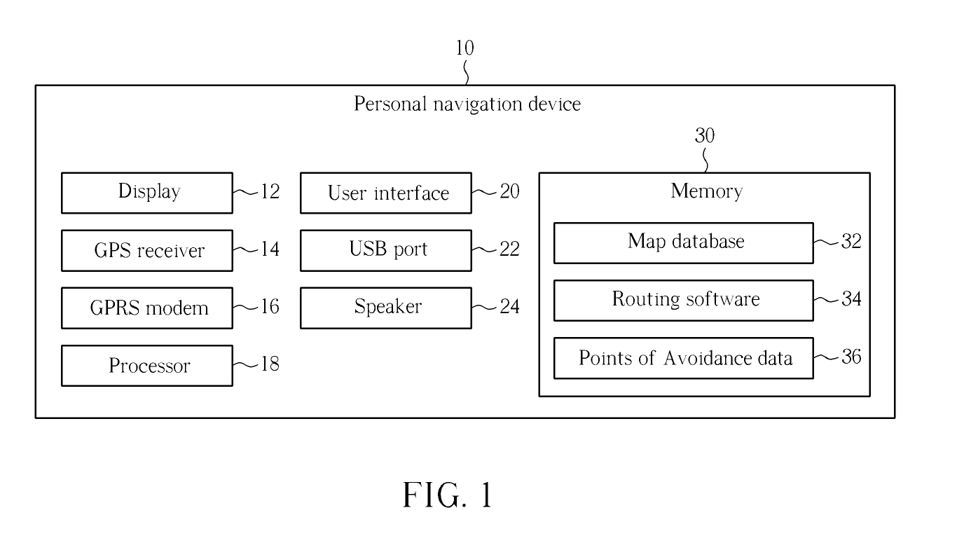

Please refer to FIG. 1. FIG. 1 is a block diagram of a personal navigation device 10 according to the present invention. The personal navigation device 10 contains a display 12 which can be a touch sensitive display, a GPS receiver 14 for receiving the current coordinates of the personal navigation device 10, a General Packet Radio Service (GPRS) modem 16 for providing internet access, a processor 18 for controlling operation of the personal navigation device 10, a user interface 20, a Universal Serial Bus (USB) port 22 for allowing data to be exchanged with a computer, a speaker 24, and memory 30. The memory 30 is used to store a map database 32 containing map data and points of interest. The memory 30 also stores routing software 34 as well as points of avoidance data 36.

In the present invention, users can create points of avoidance, each specifying position information such as latitude/longitude data, sections of a road or highway, or specific junctions or intersections. Also, specific road directions at certain intersections can be avoided as well. For instance, the user may prefer not to turn left (or right) onto one road at a particular intersection although going any other direction through the intersection is acceptable to the user.

The points of avoidance can also have times associated with them during which the locations should be avoided, such as during rush hour. These points of avoidance are stored in the points of avoidance data 36 section of memory 30. The user can input these points of avoidance through the user interface 20 of the personal navigation device 10, or the user can import existing points of avoidance from a server or a computer. The GPRS modem 16, or any similar such communication device, can be used to communicate with a server via the internet for downloading points of avoidance. The USB port 22 can also be used for importing points of avoidance from a computer into the points of avoidance data 36 section of memory 30. When the user imports points of avoidance into the personal navigation device 10, the user can choose to import all available points of avoidance, only those points of avoidance located in a specific geographical area, or only those points of avoidance belonging to a specific category selected by the user.

After storing the points of avoidance into the points of avoidance data 36 section of memory 30, the user can ask the personal navigation device 10 for routing instructions by inputting a destination through the user interface 20 of the personal navigation device 10. The routing software 34 will then do its best to generate a route that avoids the points of avoidance selected by the user. If it is not possible to avoid one or more points of avoidance, the routing software 34 will issue a warning to the user through the display 12 or the speaker 24.

Several different types of users may benefit from the present invention method of avoiding points of avoidance. For instance, users that regularly commute to work or school would likely wish to avoid high traffic or highly congested streets or intersections, school zones located on the way to the destination, areas where construction is taking place, and so on. Commercial vehicle drivers may wish to avoid roads, bridges, tunnels, or intersections that have height restrictions, weight restrictions, hazardous chemical restrictions, and so forth. Users concerned about safety, such as the elderly, drivers traveling without a passenger, or pedestrians may wish to avoid areas known to be dangerous or to have high amounts of crime. Other users may wish to avoid toll roads or other routes that require a fee to be paid when traveling on that route.

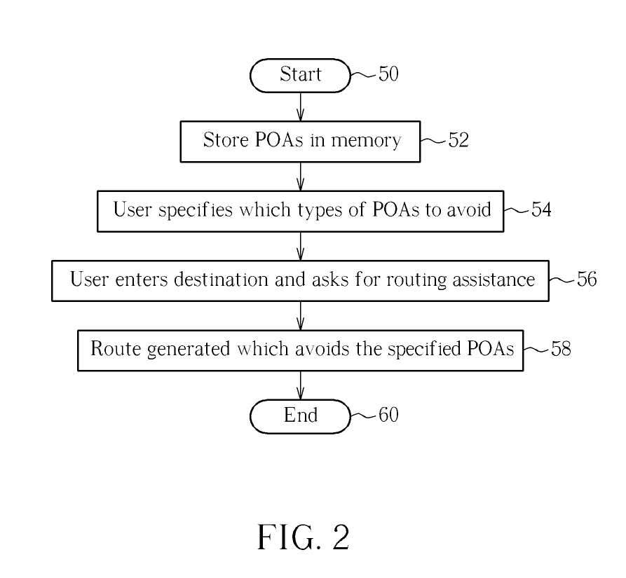

Please refer to FIG. 2. FIG. 2 is a flowchart illustrating a method of avoiding points of avoidance while generating navigation instructions with the personal navigation device 10 according to the present invention. Steps contained in the flowchart will be explained below.

Step 50: Start.

Step 52: Store points of avoidance in the points of avoidance data 36 section of memory 30. The points of avoidance can be downloaded into the personal navigation device 10 or can be input directly by the user using the user interface 20.

Step 54: The user specifies which types of points of avoidance should be avoided. The user can select individual points of avoidance or can select by categories, as will be explained in greater detail below.

Step 56: The user enters a destination into the personal navigation device 10 and asks for routing assistance.

Step 58: The routing software 34 of the personal navigation device 10 generates a route for the user that avoids as many of the specified points of avoidance as possible.

Step 60: End.

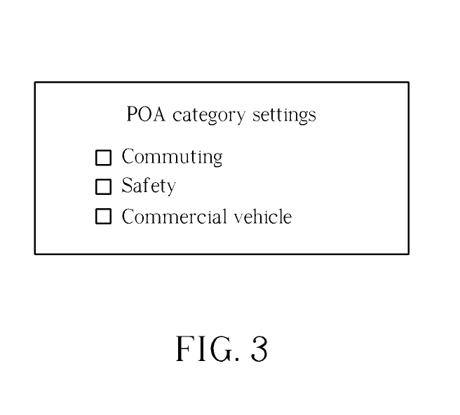

As mentioned above, the user can select points of avoidance by categories for convenience. Please refer to FIG. 3. FIG. 3 shows categories of points of avoidance that may be selected by the user of the personal navigation device 10. Three example categories are shown in FIG. 3, although this present invention is not limited to these categories. The commuting category contains locations that are known to be troublesome for commuters such as congested streets or intersections, school zones, construction areas, and so on. The safety category contains locations that are known to have high crime rates or that are otherwise considered dangerous. The commercial vehicle category contains locations that drivers of commercial vehicles may wish to avoid, such as roads, bridges, tunnels, or intersections that have height restrictions, weight restrictions, hazardous chemical restrictions, etc. A user can check one or more of the boxes shown in FIG. 3 for avoiding these types of points of avoidance.

Furthermore, the user can set personal preferences for indicating data specific to the user or the user's vehicle. For example, for the commuting category, the user can specify the user's regular commuting time. For the commercial vehicle category, the user can specify the vehicle's height, weight, cargo type, etc. Based on these personal preferences, the points of avoidance can be filtered so that only the applicable points of avoidance are avoided by the routing software 34.

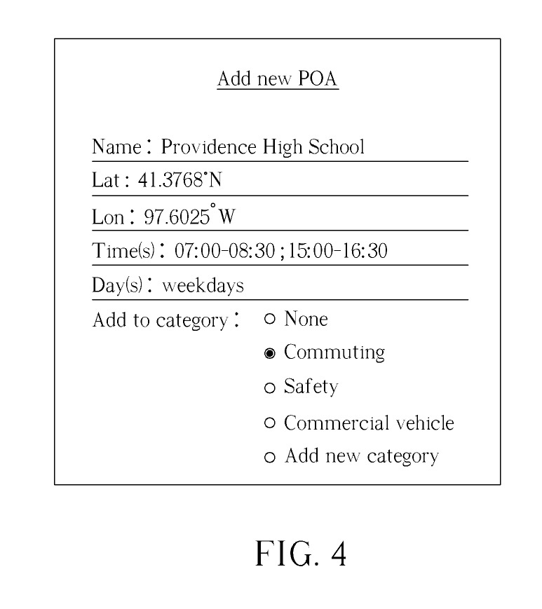

Please refer to FIG. 4. FIG. 4 shows an example of a new point of avoidance being created and all of the associated parameters. When a new point of avoidance is created, it can be labeled with a name, for example “Providence High School”. A location associated with the point of avoidance is indicated, such as through latitude and longitude coordinates. Alternatively, the location can be specified as a stretch of road, a road intersection, a bridge, a tunnel, and so on. If applicable, a time of day and a time of the week that the location should be avoided can be specified. In this example, since the point of avoidance is a high school, it should be avoided from 7:00 AM to 8:30 AM and from 3:00 PM to 4:30 PM every weekday. Finally, this new point of avoidance can be categorized so that is included in a group of points of avoidance that are selected according to a specific category. The new point of avoidance can be added to one of the existing categories or a new category can be created for the new point of avoidance. In this case, the point of avoidance can be added to the commuting category so that the school zone surrounding the high school can be avoided during commuting hours.

In summary, the present invention provides a way for users to avoid points of avoidance that the user wishes to avoid when receiving navigation instructions from the personal navigation device. In this way, the user can have a more enjoyable trip that is free of known trouble spots. As an added benefit, the points of avoidance can help the personal navigation device create a faster and safer route for the user.

Those skilled in the art will readily observe that numerous modifications and alterations of the device and method may be made while retaining the teachings of the invention.

What is claimed is:

1. A method of incorporating points of avoidance into navigation instructions generated by a personal navigation device, the method comprising:
storing a plurality of points of avoidance into a memory of the personal navigation device, each point of avoidance having corresponding position coordinates, wherein the points of avoidance correspond to locations having a property selected from the group consisting of vehicle height restrictions, vehicle weight restrictions, time of day, day of week, a category of points of avoidance selected by the user, current traffic status, and required fees;
receiving a request from a user of the personal navigation device to provide navigation instructions to a destination;
creating a route that avoids the points of avoidance; and
providing navigation instructions to guide the user on the created route.

2. The method of claim 1, wherein at least one of the points of avoidance has an associated time of day or time of the week during which the corresponding position coordinates should be avoided.

3. The method of claim 1, wherein the points of avoidance stored in the memory belong to a category of points of avoidance selected by the user.

4. The method of claim 3, wherein the category of points of avoidance avoids locations having vehicle height or weight restrictions.

5. The method of claim 3, wherein the category of points of avoidance avoids locations requiring a fee or a toll to be paid.

6. The method of claim 3, wherein the category of points of avoidance avoids school zones.

7. The method of claim 3, wherein the category of points of avoidance avoids high traffic areas.

8. The method of claim 3, wherein the category of points of avoidance avoids areas known not to be safe.

9. The method of claim 3, wherein the category of points of avoidance avoids road directions at particular intersections.

10. The method of claim 1 further comprising downloading points of avoidance from an online library and storing the downloaded points of avoidance in the memory of the personal navigation device.

11. A personal navigation device for avoiding points of avoidance in navigation instructions generated by the personal navigation device, comprising:
a memory for storing a plurality of points of avoidance, each point of avoidance having corresponding position coordinates, wherein the points of avoidance correspond to locations having a property selected from the group consisting of vehicle height restrictions, vehicle weight restrictions, time of day, day of week, a category of points of avoidance selected by the user, current traffic status, and required fees;
a user interface for receiving a request from a user of the personal navigation device to provide navigation instructions to a destination;
routing software for creating a route that avoids the points of avoidance and providing navigation instructions to guide the user on the created route; and
a processor for controlling operation of the personal navigation device and controlling execution of the routing software.

12. The personal navigation device of claim 11, wherein at least one of the points of avoidance has an associated time of day or time of the week during which the corresponding position coordinates should be avoided.

13. The personal navigation device of claim 11, wherein the points of avoidance stored in the memory belong to a category of points of avoidance selected by the user.

14. The personal navigation device of claim 13, wherein the category of points of avoidance avoids locations having vehicle height or weight restrictions.

15. The personal navigation device of claim 13, wherein the category of points of avoidance avoids locations requiring a fee or a toll to be paid.

16. The personal navigation device of claim 13, wherein the category of points of avoidance avoids school zones.

17. The personal navigation device of claim 13, wherein the category of points of avoidance avoids high traffic areas.

18. The personal navigation device of claim 13, wherein the category of points of avoidance avoids areas known not to be safe.

19. The personal navigation device of claim 13, wherein the category of points of avoidance avoids road directions at particular intersections.

20. The personal navigation device of claim 11 further comprising a communications port for enabling the user to download downloading points of avoidance from an online library and storing the downloaded points of avoidance in the memory of the personal navigation device.
